(19) United States
(12) Patent Application Publication
(10) Pub. No.: US 2015/0372272 A1
(43) Pub. Date: Dec. 24, 2015

(54) NEGATIVE ELECTRODE MATERIAL FOR LITHIUM ION SECONDARY BATTERIES

(71) Applicant: HITACHI, LTD, Tokyo (JP)

(72) Inventor: Norio IWAYASU, Tokyo (JP)

(73) Assignee: HITACHI, LTD., Tokyo (JP)

(21) Appl. No.: 14/762,619

(22) PCT Filed: Feb. 1, 2013
(86) PCT No.: PCT/JP2013/052309

§ 371 Date: Jul. 22, 2015

(51) Int. Cl. H01M 2/16; H01M 10/0525

(52) U.S. Cl. CPC H01M 2/1673; H01M 10/0525

(57) ABSTRACT

Provided is a negative electrode material for lithium ion batteries, which has a small irreversible capacity, low resistance and excellent output characteristics. In a negative electrode active material-coating material (Formula 1) for lithium ion secondary batteries, A represents a functional group having an amide group (—NHCO—) and a sulfo group (—SO₃X, wherein X is an alkali metal or H), and B represents a functional group having a polar functional group. In the (Formula 1), R1 to R6 represent a hydrocarbon group having 1-10 carbon atoms, or H. In the (Formula 1), x and y represent the composition ratio of copolymerization, which is 0<x/(x+y)≦1.

### TECHNICAL FIELD

The present invention relates to a negative electrode material for lithium ion secondary batteries.

### BACKGROUND ART

In recent years, materials for lithium ion secondary batteries have been actively developed. In a negative electrode active material for lithium ion secondary batteries, a decrease in irreversible capacity based on the reductive decomposition of an electrolyte solution has been an important problem. There has been, therefore, an attempt to decrease the irreversible capacity by coating the surface of a negative electrode active material with a polymer.

PTL 1 discloses a technique in which a polyethylene oxide polymer is added to electrodes. PTL 2 discloses a technique in which a polyaniline sulfonic acid is combined with electrodes. PTL 3 discloses a technique in which a polymer containing a sulfonic acid ion group is combined with electrodes. PTL 4 discloses a technique for a negative electrode material containing carbon clusters having a sulfoalkyl group.

### CITATION LIST

### Patent Literature

PTL 1: JP 2010-009773 A

PTL 2: JP 2009-117322 A

PTL 3: JP 2007-042387 A

PTL 4: JP 2006-179468 A

### SUMMARY OF INVENTION

### Technical Problem

When a negative electrode active material is coated with polymers in PTLs 1 to 4, however, there are problems in that battery resistance is increased and output characteristics decrease. It is believed that because polyethylene oxide described in PTL 1 has high coordination bond properties with lithium ions, resistance is increased. The polymers described in PTLs 2 to 4 all have a sulfo group as a polar functional group. The sulfo group is a functional group which increases the dissociation of lithium ions; however, in all the polymers, dissociation decreases due to the influence of functional groups substituting on the sulfo group. Consequently, it is assumed that battery resistance increases. It is believed that the development of materials including a substituent to increase the dissociation degree of sulfo groups is required for a decrease in battery resistance. Therefore, an object of the present invention is to provide a novel negative electrode active material-coating material, which has a small irreversible capacity and does not increase resistance even when coated with a polymer.

### Solution to Problem

The features of the present invention to solve the above problems are as follows.

A negative electrode active material-coating material for lithium ion secondary batteries, which is represented by the (Formula 1).

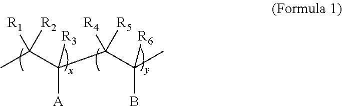

In the (Formula 1), A represents a functional group having an amide group (—NHCO—) and a sulfo group (—SO₃X, wherein X represents an alkali metal or H) . B represents a functional group having a polar functional group. In the (Formula 1) , R₁ to R₆ represent a hydrocarbon group having 1-10 carbon atoms, or H. In the (Formula 1) , x and y represent a composition ratio of copolymerization, which is 0<x/(x+y)≦1.

A in the (Formula 1) is, for example, represented by the (Formula 2) .

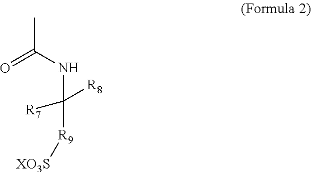

In the (Formula 2) , R₇ and R₈ represent an alkyl group having 1-10 carbon atoms, or H. In the (Formula 2) , R₉ represents a methylene group (—(—CH₂—)ₙ—) , wherein n is 0 or more to 10 or less. In the (Formula 2), X represents an alkali metal or H.

As B, a functional group containing a hydroxy group, a carboxyl group, a sulfo group and/or an amino group can be used.

### Advantageous Effects of Invention

According to the present invention, there can be provided a negative electrode material for lithium ion batteries, which has a small irreversible capacity, low resistance and excellent output characteristics. The problems, composition and effects other than those described will become clear by the following descriptions of embodiments.

### BRIEF DESCRIPTION OF DRAWING

FIG. 1 is a figure schematically showing the inner structure of the battery involved in an embodiment of the present invention.

### DESCRIPTION OF EMBODIMENTS

The embodiments of the present invention will now be described using the drawing and the like. The following descriptions show specific examples of the contents of the present invention, and the present invention is not restricted to these descriptions and can be variously changed and modified by those of skill in the art within the scope of technical ideas disclosed herein. In all the drawings to illustrate the present invention, parts with the same function are indicated with the same sign and the descriptions thereof are not repeated and can be omitted.

<Battery Structure>

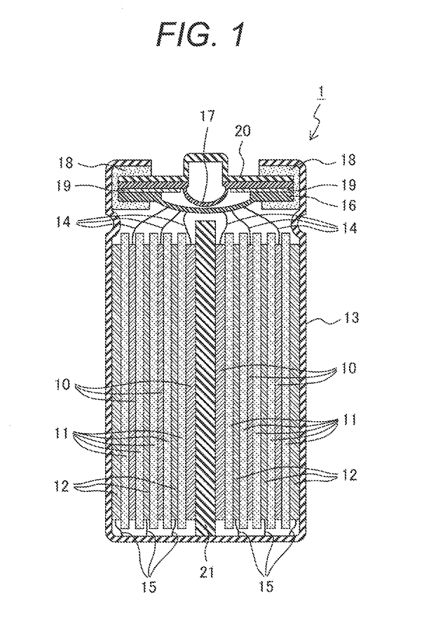

FIG. 1 is a figure schematically showing the inner structure of the battery involved in an embodiment of the present invention. The battery 1 involved in an embodiment of the present invention, shown in FIG. 1, is constituted of the positive electrode 10, the separator 11, the negative electrode 12, the battery container (i.e. battery can) 13, the positive electrode current collector tab 14, the negative electrode current collector tab 15, the inner cover 16, the internal pressure release valve 17, the gasket 18, the positive temperature coefficient (PTC) resistive element 19, the battery cover 20 and the shaft 21. The battery cover 20 is an integrated part consisting of the inner cover 16, the internal pressure release valve 17, the gasket 18 and the PTC resistive element 19. In addition, the positive electrode 10, the separator 11 and the negative electrode 12 are wrapped around the shaft 21.

The separator 11 is inserted between the positive electrode 10 and the negative electrode 12, and an electrode group wrapped around the shaft 21 is produced. Any known shafts which can support the positive electrode 10, separator 11 and negative electrode 12 can be used as the shaft 21. In addition to the electrode group in a cylindrical shape shown in FIG. 1, those with various shapes can be produced, for example one in which electrodes in a rectangular shape are laminated or one in which the positive electrode 10 and negative electrode 12 are wrapped in any shape such as a flat shape. As the shape of the battery container 13, for example, cylindrical, flat elliptical, flat oval and square shapes can be selected depending on the shape of the electrode group.

The material for the battery container 13 is selected from materials with corrosion resistance against nonaqueous electrolytes such as aluminum, stainless steel and nickel plating steel. When the battery container 13 is electrically connected to the positive electrode 10 or negative electrode 12, the material for the battery container 13 is selected so that the corrosion of the battery container 13 and material deterioration due to alloying with lithium ions will not occur in a portion which is brought into contact with a nonaqueous electrolyte.

The electrode group is put in the battery container 13, the negative electrode current collector tab 15 is connected to the inner wall of the battery container 13, and the positive electrode current collector tab 14 is connected to the underside of the battery cover 20. An electrolyte solution is injected into the inside of the battery container 13 before the battery is closed tightly. As a method for injecting an electrolyte solution, there is a method by directly adding an electrolyte solution to the electrode group with the battery cover 20 open, or a method by adding an electrolyte solution from an inlet made on the battery cover 20.

After this, the battery cover 20 is appressed to the battery container 13 and the whole battery is tightly closed. An inlet to inject an electrolyte solution is also sealed if it is. As a method for tightly closing batteries, there are known techniques such as welding and caulking.

The lithium ion battery involved in an embodiment of the present invention can be produced, for example, by placing a negative electrode and a positive electrode as described below facing each other via a separator and injecting an electrolyte therein. The structure of the lithium ion battery involved in an embodiment of the present invention is not particularly limited, and can be usually a wrapped electrode group obtained by wrapping a positive electrode and a negative electrode and a separator, which separates these electrodes, or a laminated electrode group obtained by laminating a positive electrode, a negative electrode and a separator.

<Positive Electrode>

The positive electrode 10 is constituted of a positive electrode active material, a conductive agent, a binder and a current collector. When positive electrode active materials are exemplified, typical examples thereof are LiCoO₂, LiNiO₂ and LiMn₂O₄. Other examples can include LiMnO₃, LiMn₂O₃, LiMnO₂, Li₄Mn₅O₁₂, LiMn₂₋ₓMxO₂ (wherein M is at least one selected from the group consisting of Co, Ni, Fe, Cr, Zn and Ti, and x is 0.01 to 0.2), Li₂Mn₃MO₈ (wherein M is at least one selected from the group consisting of Fe, Co, Ni, Cu and Zn), Li₁₋ₓAₓMn₂O₄ (wherein A is at least one selected from the group consisting of Mg, B, Al, Fe, Co, Ni, Cr, Zn and Ca, and x is 0.01 to 0.1), LiNi₂₋ₓMₓO₂ (wherein M is at least one selected from the group consisting of Co, Fe and Ga, and x is 0.01 to 0.2), LiFeO₂, Fe₂ (SO₄)₃, LiCo₁₋ₓMₓO₂ (wherein M is at least one selected from the group consisting of Ni, Fe and Mn, and X is 0.01 to 0.2), LiNi₁₋ₓMₓO₂ (wherein M is at least one selected from the group consisting of Mn, Fe, Co, Al, Ga, Ca and Mg, and x is 0.01 to 0.2), Fe(MoO₄)₃, FeF₃, LiFePO₄, and LiMnPO₄ and the like.

The particle diameter of a positive electrode active material is usually defined to be equal to or smaller than the thickness of a mixture layer formed from the positive electrode active material, a conductive agent and a binder. When there are crude particles with a size equal to or larger than the thickness of the mixture layer in positive electrode active material powder, it is preferred that particles with a size equal to or smaller than the thickness of the mixture layer be produced by removing crude particles in advance with e.g. sieve classification and wind flow classification.

In addition, positive electrode active materials generally have high electric resistance due to being oxides, and thus a conductive agent including carbon powder to cover electroconductivity is utilized. Because positive electrode active materials and conductive agents are both usually powders, particles in the powders can be bound to each other and simultaneously adhered to a current collector by mixing a binder with the powders.

As a current collector of positive electrode 10, for example, aluminum foil with a thickness of 10 to 100 μm, aluminum perforated foil with a thickness of 10 to 100 μm and a hole diameter of 0.1 to 10 mm, an expanded metal, or a foam metal plate is used. In addition to aluminum, materials such as stainless and titanium can be also applied. In the present invention, any current collectors can be used without being limited to the materials, shapes, production methods and the like.

A positive electrode slurry obtained by mixing a positive electrode active material, a conductive agent, a binder and an organic solvent is applied to a current collector by e.g. the doctor blade method, the dipping method or the spray method. The organic solvent is then dried, and the positive electrode 10 can be produced by pressure forming using a roll press. In addition, a plurality of mixture layers can be laminated to a current collector by repeating from application to drying several times.

<Negative Electrode>

The negative electrode includes a negative electrode active material, a binder and a current collector. As the negative electrode active material, those in which materials which are easily graphitized obtained from e.g. natural graphite, petroleum coke and pitch coke are treated by heating at a high temperature of 2500° C. or more, mesophase carbon or amorphous carbon, carbon fiber, metals alloyed with lithium, or materials supporting a metal on carbon particle surfaces are used. Examples thereof are metals selected from lithium, silver, aluminum, tin, silicon, indium, gallium and magnesium or alloys. In addition, the metals or oxides of the metals can be utilized as a negative electrode active material. Further, lithium titanate can be also used.

A negative electrode active material is coated with a compound represented by the (Formula 1). In the (Formula 1), A represents a functional group having an amide group (—NHCO—) and a sulfo group (—SO₃X, wherein X is an alkali metal or H). B is a functional group having a polar functional group. In the (Formula 1), R₁ to R₆ represent a hydrocarbon group having 1-10 carbon atoms, or H. In the (Formula 1), x and y represent the composition ratio of copolymerization.

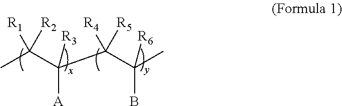

Because A has a sulfo group, the dissociation of lithium ions can be increased. Consequently, an effect of decreasing battery resistance is obtained. X in —SO₃X is an alkali metal and, for example, Li, Na, K, Rb, Cs, Fr and the like can be used. Li, Na and K are preferably used in terms of battery efficiency.

Because A has an amide group, the dissociation of polar functional groups can be further increased. Therefore, an effect of decreasing battery resistance is obtained.

In the (Formula 1), A is represented, for example, by the (Formula 2).

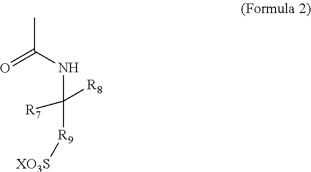

In the (Formula 2), R₇ and R₈ represent an alkyl group or H.

As the alkyl group, a methyl group is suitably used in terms of electrochemical stability. In the (Formula 2), R₉ represents a methylene group (-(—CH₂-)n-), wherein n is 0 or more to 10 or less, and n is preferably 1 or more to 5 or less in terms of ionic conductivity. In the (Formula 2), X represents an alkali metal or H.

The (Formula 1) can be produced by copolymerizing an A-containing monomer and a B-containing monomer. In the (Formula 1), B represents a polar functional group and, for example, a functional group containing a hydroxy group, a carboxyl group, a sulfo group and/or an amino group can be used. Functional groups containing a carboxyl group and a sulfo group are particularly suitably used. In addition, esters and alkali metal salts thereof can be used. Among these, the alkali metal salts of carboxyl group and sulfo group do not contain active hydrogen, and the effect of the present invention is thus increased. In addition, by selecting the above functional group, the reductive decomposition of an electrolyte solution occurring on a negative electrode is suppressed and the irreversible capacity can be decreased. A polymer synthesized by only monomer A is excellent in terms of low resistance values. However, a coat which is excellent in terms of a decrease in irreversible capacity is obtained by adding monomer B.

An example of B includes the structure represented by the (Formula 3). In the (Formula 3), the sulfo group can be changed to a hydroxy group, a carboxyl group or an amino group.

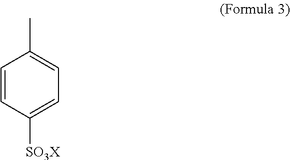

The polymerization of an A-containing monomer and the copolymerization of an A-containing monomer and a B-containing monomer can be carried out by any of bulk polymerization, solution polymerization and emulsion polymerization which have been known until now. The polymerization method is not particularly limited and radical polymerization is suitably used. Polymerization can be carried out using a polymerization initiator or can be carried out without using it, and a radical polymerization initiator is preferably used in terms of easy handling. The polymerization method using a radical polymerization initiator can be carried out with a commonly used temperature range and polymerization time. The amount of initiator combined in the present invention is 0.1 wt % to 20 wt % with respect to that of polymerizable compounds and preferably 0.3 wt % or more to 5 wt %.

In the present invention, the composition ratio of copolymerization in the (Formula 1) is important to obtain the effect of the present invention. The x/(x+y) is 0<x/(x+y)≦1 and preferably 0.4≦x/(x+y)≦1. By controlling the x/(x+y), the mobility of polymer ions increases and lithium ion secondary batteries with excellent output characteristics can be provided.

Examples of polymers in which monomer A and monomer B are copolymerized include those of the Formula 4.

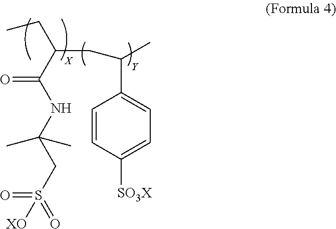

About the negative electrode-coating material of the present invention, the method for coating a negative electrode active material with the above coating material is not particularly considered, as long as the polymer is coated on the negative electrode active material. The coating method by dissolving a polymer in a solvent, adding a negative electrode active material to the solution, stirring the obtained mixture, and then drying the solvent is preferred in terms of costs. The solvent is not particularly considered, as long as a polymer is dissolved therein, and protic solvents such as water and ethanol, aprotic solvents such as N-methyl pyrrolidone, and nonpolar solvents such as toluene and hexane, and the like are suitably used.

The amount coated is an important value to obtain the effect of the present application. The amount coated is 0.01 wt % or more to 10 wt % or less, preferably 0.1 wt % or more to 1 wt % or less, and particularly preferably 0.3 wt % or more to 0.9 wt % or less with respect to that of negative electrode active material.

<Separator>

The separator 11 is inserted between the positive electrode 10 and the negative electrode 12 produced by the above method to prevent short circuits in the positive electrode 10 and the negative electrode 12. A polyolefin polymer sheet including e.g. polyethylene or polypropylene, or a two layer structure obtained by welding a polyolefin polymer and a fluorine polymer sheet typified by polytetrafluoroethylene, or the like can be used as the separator 11. A mixture of ceramic and binder can be formed in a thin layer form on the surface of the separator 11 so that the separator 11 will not be shrunk when the battery temperature is raised. Because it is required to permeate lithium ions when batteries are charged and discharged, these separators 11 having a pore diameter of 0.01 to 10 μm and a porosity of 20 to 90% can be generally used for lithium ion batteries.

<Electrolyte>

A typical example of electrolyte solutions which can be used in an embodiment of the present invention is a solution in which as an electrolyte, lithium hexafluorophosphate (LiPF₆) or lithium tetrafluoroborate (LiBF₄) is dissolved in a solvent obtained by mixing dimethyl carbonate, diethyl carbonate or ethyl methyl carbonate or the like with ethylene carbonate. The present invention is not restricted to the solvents, types of electrolyte and mixing ratio of solvents, and other electrolyte solutions can be also used.

Examples of nonaqueous solvents which can be used for electrolyte solutions are nonaqueous solvents such as propylene carbonate, ethylene carbonate, butylene carbonate, vinylene carbonate, γ-butyrolactone, dimethyl carbonate, diethyl carbonate, methylethyl carbonate, 1,2-dimethoxyethane, 2-methyltetrahydrofuran, dimethylsulfoxide, 1,3-dioxolane, formamide, dimethylformamide, methyl propionate, ethyl propionate, phosphate triester, trimethoxymethane, dioxolane, diethylether, sulfolane, 3-methyl-2-oxazolidinone, tetrahydrofuran, 1,2-diethoxyethane, chloroethylene carbonate or chloropropylene carbonate. In addition to these solvents, other solvents which are not decomposed on the positive electrode 10 or the negative electrode 12 included in the battery of the present invention can be also used.

Examples of electrolytes are a variety of lithium salts such as LiPF₆, LiBF₄, LiClO₄, LiCF₃SO₃, LiCF₃CO₂, LiAsF₆, LiSbF₆ or lithium imide salts typified by lithium trifluoromethanesulfonimide. Nonaqueous electrolyte solutions obtained by dissolving these salts in the above solvents can be used as electrolyte solutions for batteries. In addition to these electrolytes, other electrolytes which are not decomposed on the positive electrode 10 and the negative electrode 12 of the battery involved in the present embodiment can be used.

When a solid polymer electrolyte (polymer electrolyte) is used, ion-conducting polymers such as polyethylene oxide, polyacrylonitrile, polyvinylidene fluoride, poly methyl methacrylate, poly hexafluoropropylene and polyethylene oxide can be used as an electrolyte. When these solid polymer electrolytes are used, there is an advantage that the separator 11 can be reduced.

Further, ionic liquids can be used. Among, for example, 1-ethyl-3-methylimidazolium tetrafluoroborate (EMI-BF₄), a mixed complex of a lithium salt LiN(SO₂CF₃)₂ (LiTFSI), triglyme and tetraglyme, cyclic quaternary ammonium cations (e.g. N-methyl-N-propylpyrrolidinium), and imide anions (e.g. bis(fluorosulfonyl)imide), combinations which are not decomposed on the positive electrode 10 and negative electrode 12 are selected and can be used for the battery involved in the present embodiment.

### EXAMPLES

The present invention will now be described in more detail by way of examples thereof . It should be noted, however, that the present invention is not limited to these examples. The results of the examples were summarized in Table 1.

### <Synthesis Method for Polymers>

Monomers and water as a reaction solvent were added into a reaction container. AIBN was further added to the solution as a polymerization initiator. The polymerization initiator was added so as to have a concentration of 4 wt % with respect to the total amount of monomers. After this, the reaction solution was heated at 60° C. for 3 hours to synthesize a polymer.

### <Production Method for Positive Electrode>

A positive electrode active material, a conductive agent (SP270: graphite manufactured by Nippon Graphite Industries, Co., Ltd.), and a polyvinylidene fluoride binder were mixed in a proportion of 85:10:10 wt %, and the obtained mixture was added to and mixed with N-methyl-2-pyrrolidone to produce a slurry solution. The slurry was applied to aluminum foil with a thickness of 20 μm by the doctor blade method and dried. The amount of mixture applied was 200 g/m². After this, a positive electrode was produced by pressing.

### <Production Method for Negative Electrode>

Graphite and polyvinylidene fluoride were mixed in a ratio of 95:5 wt %, and the obtained mixture was further added to and mixed with N-methyl-2-pyrrolidone to produce a slurry solution. The slurry was applied to copper foil with a thickness of 10 μm by the doctor blade method and dried. A negative electrode was produced by pressing so that the bulk density of mixture was 1.5 g/cm³.

### <Evaluation Method for Negative Monopole>

An electrode was prepared by punching a circle with a diameter of 15 mm through the produced negative electrode. An evaluation cell was constituted using the negative electrode and Li metal as the opposite pole by inserting a separator between the negative electrode and the Li metal and adding an electrolyte solution thereto. The evaluation cell was charged to the lower limit voltage set in advance at an electric current density of 0.72 mA/cm². The cell was discharged to the upper limit voltage set in advance at an electric current density of 0.72 mA/cm². The lower limit voltage was 0.01 V and the upper limit voltage was 1.5 V. The irreversible capacity was obtained from a difference between charge capacity and discharge capacity.

### <Evaluation Method for Direct Current Resistance>

Electrodes were prepared by punching a circle with a diameter of 15 mm through a positive electrode and a negative electrode. A small battery was constituted by inserting a separator between the positive electrode and negative electrode and adding an electrolyte solution thereto. The small battery was charged to the upper limit voltage set in advance at an electric current density of 0.72 mA/cm². The battery was discharged to the lower limit voltage set in advance at an electric current density of 0.72 mA/cm². The upper limit voltage was 4.2 V and the lower limit voltage was 3.0 V. The discharge capacity obtained in the first cycle was considered as the initial capacity of the battery. After this, the battery was charged to 50% of the initial capacity and the direct current resistance was measured.

### Example 1

A monomer of the (Formula 5) was used as Monomer A to synthesize a polymer. In addition, a negative electrode active material was coated using the above polymer. Graphite was used as the negative electrode active material.

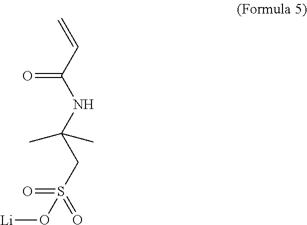

A negative monopole was produced and its irreversible capacity was measured. The irreversible capacity was 23 mAhg⁻¹. Next, a small battery was produced and its direct current resistance was measured. The direct current resistance was 11.0 Ω.

### Example 2

An evaluation was made in the same manner as in Example 1 except that the polymer amount in Example 1 was changed to 0.1 wt %. The irreversible capacity was 24 mAhg⁻¹ and the direct current resistance was 11.2 Ω.

### Example 3

An evaluation was made in the same manner as in Example 1 except that the polymer amount in Example 1 was changed to 1.0 wt %. The irreversible capacity was 23 mAhg⁻¹ and the direct current resistance was 11.5 Ω.

### Example 4

A polymer was synthesized using the monomer of the (Formula 3) as Monomer A and sodium styrene sulfonate as Monomer. The mol ratio of Monomer A and Monomer B was 75:25. A negative electrode active material was coated in the same manner as in Example 1 and its characteristics were evaluated. The irreversible capacity was 21 mAhg⁻¹ and the direct current resistance was 11.1 Ω.

### Example 5

A polymer was synthesized in the same manner as in Example 4 except that the mol ratio of monomers in Example 4 was changed to 50:50. The irreversible capacity was 23 mAhg⁻¹ and the direct current resistance was 11.1 Ω.

### Example 6

A polymer was synthesized in the same manner as in Example 4 except that the mol ratio of monomers in Example 4 was changed to 25:75. The irreversible capacity was 23 mAhg⁻¹ and the direct current resistance was 12.0 Ω.

### Comparative Example 1

An examination was made in the same manner as in Example 1 except that a coating material in Example 1 was not added. The irreversible capacity was 25 mAhg⁻¹and the direct current resistance was 11.5 Ω.

### Comparative Example 2

A polymer was synthesized in the same manner as in Example 4 except that the mol ratio of monomers in Example 4 was changed to 0:100. The irreversible capacity was 22 mAhg⁻¹ and the direct current resistance was 13.1 Ω.

The comparisons between Comparative Example 1 and Examples 1 to 6 could verify that irreversible capacities could be decreased by coating the negative electrode active material with Polymers A, B, C and D. This is believed that the reductive decomposition of electrolyte solutions was prevented by coating the negative electrode active material.

In addition, it was verified that Polymer A in which Monomer A was polymerized had low resistance values compared to those of Polymers B, C and D containing Monomer B. It could be also verified that polymers containing Monomer B were excellent in terms of a decrease in irreversible capacity. It was verified that Polymer E consisting of only Monomer B had a high direct current resistance value compared to those of polymers containing Monomer A. From these results, it was verified that the ratio of Monomer A and Monomer B, x and y, was 0<x/(x+y)≦1, preferably 0.25<x/(x+y)≦1 and further preferably 0.4≦x/(x+y)≦1.

TABLE 1

| | | | | | | | NEGATIVE | |
|---|---|---|---|---|---|---|---|---|
| | | | | | | | MONOPOLE | BATTERY |
| | | | | | | | EVALUATION | EVALUATION |
| | | MONOMER | | | | COATED | IRREVERSIBLE | DIRECT |
| | POLYMER | COMPOSITION | | mol % | | AMOUNT/ | CAPACITY/ | CURRENT |
| | NAME | a | b | a | b | wt % | mAhg⁻¹ | RESISTANCE/Ω |
| EXAMPLE | | | | | | | | |
| 1 | A | MONOMER A | — | 100 | 0 | 0.5 | 23 | 11.0 |
| 2 | A | MONOMER A | — | 100 | 0 | 0.1 | 24 | 11.2 |
| 3 | A | MONOMER A | — | 100 | 0 | 1.0 | 23 | 11.5 |
| 4 | B | MONOMER A | MONOMER B | 75 | 25 | 0.5 | 21 | 11.2 |
| 5 | C | MONOMER A | MONOMER B | 50 | 50 | 0.5 | 23 | 11.1 |
| 6 | D | MONOMER A | MONOMER B | 25 | 75 | 0.5 | 23 | 12.0 |
| COMPARATIVE | | | | | | | | |
| EXAMPLE | | | | | | | | |
| 1 | — | NOT COATED | | — | — | — | 25 | 11.5 |
| 2 | E | — | MONOMER B | 0 | 100 | 0.5 | 22 | 13.1 |

### REFERENCE SIGNS LIST

1 battery
10 positive electrode
11 separator
12 negative electrode
13 battery container
14 positive electrode current collector tab
15 negative electrode current collector tab
16 inner cover
17 internal pressure release valve
18 gasket
19 positive temperature coefficient resistive element
20 battery cover
21 shaft

1. A negative electrode active material-coating material for lithium ion secondary batteries represented by the (Formula l), wherein A in the (Formula 1) is represented by (Formula 2): 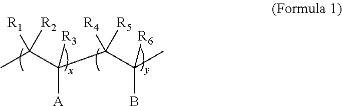
(wherein A represents a functional group having an amide group (—NHCO—) and a sulfo group (—SO₃X, wherein X represents an alkali metal or H); B represents a functional group having a polar functional group;, R₁ to R₆ represent a 1-10C hydrocarbon group or H; x and y represent a composition ratio of copolymerization; and x and y satisfy 0<x/(x+y)≦1). 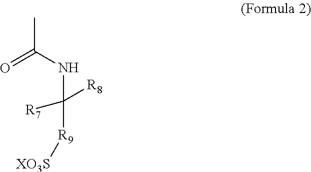
(wherein R₇ and R₈ represent a 1-10c alkyl group or H; R₉ represents a methylene group (-(—CH₂-)n-), n is 0 or more to 10 or less; and X represents an alkali metal or H).

2. (canceled)

3. The negative electrode active material-coating material for lithium ion secondary batteries according to claim 1, wherein the composition ratio of copolymerization is 0.4≦x/(x+y)≦1).

4. The negative electrode active material-coating material for lithium ion secondary batteries according to claim 3, wherein B in the (Formula 1) represents a functional group containing a hydroxy group, a carboxyl group, a sulfo group and/or an amino group.

5. The negative electrode active material-coating material for lithium ion secondary according to claim 1, wherein B in the (Formula 1) is represented by the (Formula 3).

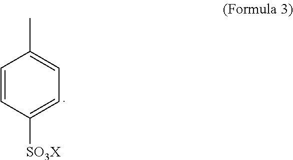

6. A negative electrode material for lithium ion batteries, which has the negative electrode active material-coating material for lithium ion secondary batteries according to claims 1 on the surface of a negative electrode active material.

7. A lithium ion secondary battery, which has the negative electrode active material according to claim 6.
